(19) United States
(12) Patent Application Publication
(10) Pub. No.: US 2013/0107417 A1
(43) Pub. Date: May 2, 2013

(54) MULTILAYERED CERAMIC ELECTRONIC COMPONENT AND METHOD OF MANUFACTURING THE SAME

(71) Applicants: Dong Su Cho, Gyunggi-Do (KR); Hyun Woo Kim, Gyunggi-Do (KR); Jae Yeol Choi, Gyunggi-Do (KR); Doo Young Kim, Gyunggi-Do (KR); Sang Hoon Kwon, Gyunggi-Do (KR); Seon Cheol Park, Hwaseong (KR)

(72) Inventors: Dong Su Cho, Gyunggi-Do (KR); Hyun Woo Kim, Gyunggi-Do (KR); Jae Yeol Choi, Gyunggi-Do (KR); Doo Young Kim, Gyunggi-Do (KR); Sang Hoon Kwon, Gyunggi-Do (KR); Seon Cheol Park, Hwaseong (KR)

(73) Assignee: SAMSUNG ELECTRO-MECHANICS CO., LTD., Suwon (KR)

(21) Appl. No.: 13/618,638

(22) Filed: Sep. 14, 2012

(30) Foreign Application Priority Data
Nov. 1, 2011 (KR) 10-2011-0112693

(51) Int. Cl. H01G 4/30

(52) U.S. Cl. 361/301.4; 29/25.42

(57) ABSTRACT

There is provided a multi-layered ceramic electronic component. The multi-layered ceramic electronic component according to embodiments of the present invention includes: a ceramic element in which a plurality of dielectric layers are stacked; and a plurality of first and second internal electrodes formed on at least one surface of the dielectric layer and alternately disposed in a width direction, wherein, when a distance from one side of the ceramic element to a leading edge of the first internal electrode in a width direction is set to be B, and a distance from one side of the ceramic element to a leading edge in a width direction of the second internal electrode thereof is set to be A, a difference between A and B is 10 to 14% of a width of the first internal electrode or the second internal electrode.

### CROSS-REFERENCE TO RELATED APPLICATIONS

This application claims the priority of Korean Patent Application No. 10-2011-0112693 filed on Nov. 1, 2011 in the Korean Intellectual Property Office, the disclosure of which is incorporated herein by reference.

### BACKGROUND OF THE INVENTION

1. Field of the Invention

The present invention relates to a multi-layered ceramic electronic component and a method of manufacturing the same.

2. Description of the Related Art

An electronic component using a ceramic material may include, for example, a capacitor, an inductor, a piezoelectric element, a varistor, a thermistor, or the like.

Among the ceramic electronic components, a multi-layered ceramic capacitor (MLCC) has strengths in terms of miniaturization, high capacity, ease of mounting, and the like.

A multilayer ceramic capacitor is a chip type condenser that may be mounted on circuit boards for various electronic products, such as computers, personal digital assistants (PDAs), mobile phones, or the like, and thus, serves to store or discharge electricity. The multilayer ceramic capacitor is configured to have various sizes and stacked shapes according to an intended application and capacity thereof.

In particular, as electronic products have recently been miniaturized, demand for the microminiaturization and implementation of supercapacitance in multi-layered ceramic capacitors used for electronic products has increased.

Therefore, in order to implement microminiaturization of products, the thickness of the dielectric layers and the internal electrodes needs to be reduced, and in order to implement supercapacity, a multi-layered ceramic capacitor in which a large number of dielectric layers are stacked has been manufactured.

The multi-layered ceramic capacitor has a structure in which internal electrodes having different polarities are alternately stacked between the plurality of dielectric layers. In this case, a charge distribution among the internal electrodes has a high charge density at an edge of the internal electrode.

Therefore, intervals between equipotential lines at the end of the internal electrode may be narrow due to the high charge density at the edge of the internal electrode, and an electrical field may be concentrated in the end of the internal electrode.

Further, in order to secure the reliability of products while satisfying the requirement for microminiaturization and the implementation of supercapacitance in the multi-layered ceramic capacitor, the multi-layered ceramic capacitor needs to have resistance against thermal impact, a temperature cycle, or the like.

However, the aforementioned local electrical field concentration phenomenon degrades the thermal resistance of the multi-layered ceramic capacitor, thereby degrading the product reliability.

### SUMMARY OF THE INVENTION

An aspect of the present invention provides a new method of reducing high charge density in an edge portion of an internal electrode of a multi-layered ceramic electronic component.

According to an aspect of the present invention, there is provided a multi-layered ceramic electronic component, including: a ceramic element in which a plurality of dielectric layers are stacked; and a plurality of first and second internal electrodes formed on at least one surface of the dielectric layer and alternately stacked to have shapes inconsistent with each other in a width direction, wherein, when a distance from one side of the ceramic element to a leading edge of the first internal electrode in a width direction is set to be B, and a distance from one side of the ceramic element to a leading edge of the second internal electrode in a width direction is set to be A, a difference between A and B is 10 to 14% of a width of the first internal electrode or the second internal electrode.

The widths of the first internal electrode and the second internal electrode may be the same.

The distance from one side of the ceramic element to the leading edge of the first internal electrode in a width direction may be the same as the distance from the other side of the ceramic element, opposite to one side thereof, to the leading edge of the second internal electrode in the width direction.

The multi-layered ceramic electronic component may further include first and second external electrodes formed on both end surfaces of the ceramic element and electrically connected with the first and second internal electrodes.

The multi-layered ceramic electronic component may further include margin part dielectric layers formed on margin parts of the dielectric layers in which the first and second internal electrodes are not formed.

The first and second internal electrodes may be disposed to face each other in a stacked direction of the ceramic element, having one dielectric layer therebetween.

According to another aspect of the present invention, there is provided a method of manufacturing a multi-layered ceramic electronic component, including: forming first and second internal electrode layers on at least one surface of first and second ceramic sheets so as to form a margin part; forming a laminate by alternately stacking the first and second ceramic sheets, each formed with the first and second internal electrode layers, several times; and firing the laminate, wherein in the forming of the first and second internal electrode layers, the margin part is formed so that the first and second internal electrode layers are alternately disposed to be inconsistent with each other in a width direction at the time of forming the laminate and when a distance from one side of the first ceramic sheet to a leading edge of the first internal electrode layer in a width direction is set to be B, and a distance from one side of the ceramic sheet to a leading edge of the second internal electrode in a width direction is set to be A, a difference between A and B is 10 to 14% of a width of the first internal electrode or the second internal electrode.

The widths of the first internal electrode layer and the second internal electrode layer may be the same.

In the forming of the first and second internal electrode layers, the distance from one side of the ceramic sheet to the leading edge of the first internal electrode layer in the width direction may be the same as the distance from the other side of the ceramic sheet, opposite to one side thereof, to the leading edge of the second internal electrode layer in the width direction.

The method of manufacturing multi-layered ceramic electronic components may further include forming first and second external electrodes formed on both surfaces of the laminate and electrically connected with the first and second internal electrode layers.

The method of manufacturing multi-layered ceramic electronic components may further include forming margin part dielectric layers on margin parts of the first and second ceramic sheets in which the first and second internal electrode layers are not formed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a schematic structure of a multi-layered ceramic capacitor according to an embodiment of the present invention;

FIG. 2 is a cross-sectional view taken along line A-A′ of FIG. 1;

FIG. 3 is an exploded perspective view schematically showing a stacked structure of first and second internal electrodes of a multi-layered ceramic capacitor according to the embodiment of the present invention;

FIG. 4 is a coupling perspective view of FIG. 3;

FIG. 5 is a cross-sectional view taken along the line B-B′ of FIG. 1;

FIG. 6 is a side cross-sectional view of a multi-layered ceramic capacitor according to another embodiment of the present invention;

FIG. 7 is a plan cross-sectional view of FIG. 6; and

FIG. 8 is an exploded perspective view schematically showing a stacked structure of first and second internal electrodes of a multi-layered ceramic capacitor according to another embodiment of the present invention.

### DETAILED DESCRIPTION OF THE INVENTION

Embodiments of the present invention will now be described in detail with reference to the accompanying drawings.

The embodiments of the present invention may be modified in many different forms and the scope of the invention should not be limited to the embodiments set forth herein.

Rather, these embodiments are provided so that this disclosure will be thorough and complete, and will fully convey the concept of the invention to those skilled in the art.

In the drawings, the shapes and dimensions may be exaggerated for clarity, and the same reference numerals will be used throughout to designate the same or like components.

In addition, like reference numerals denote parts performing similar functions and actions throughout the drawings.

In addition, unless explicitly described otherwise, “comprising” any components will be understood to imply the inclusion of other components but not the exclusion of any other components.

The present invention relates to a ceramic electronic component. An example of ceramic electronic components according to an embodiment of the present invention may include a multi-layered ceramic capacitor, an inductor, a piezoelectric element, a varistor, a chip resistor, a thermister, or the like. A multi-layered ceramic capacitor as an example of the ceramic electronic components will be described below.

Hereinafter, for convenience of explanation, in the embodiment of the present invention, a front surface of a ceramic element 110 may be referred to as a first side 200 and a back surface of the ceramic element 110 may be referred to as a second surface 210.

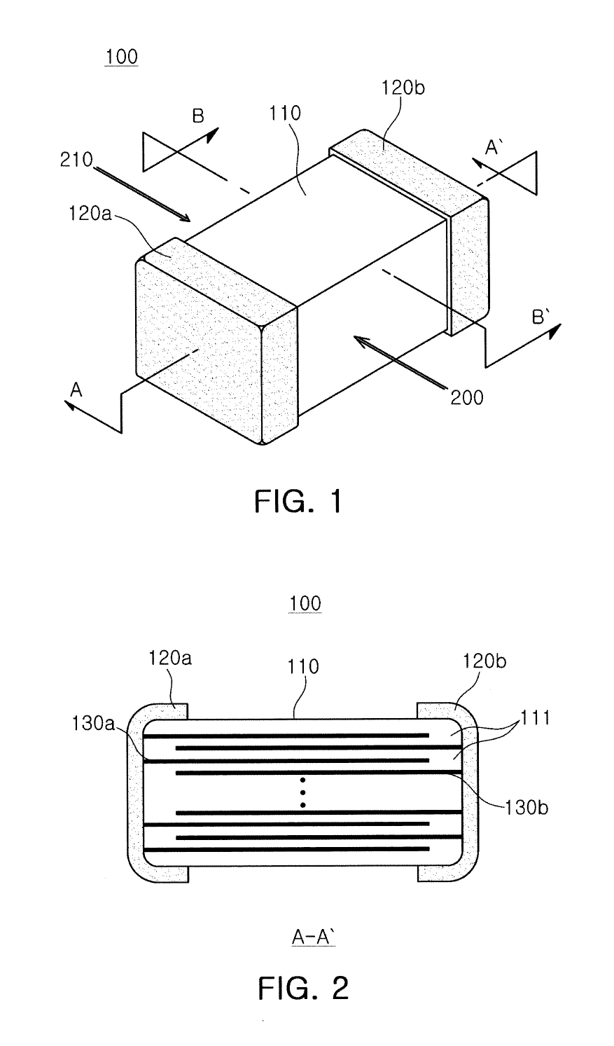

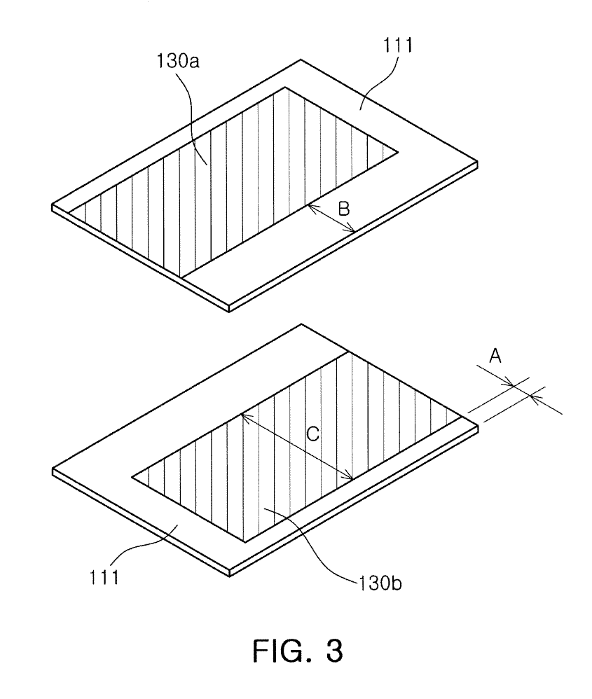

Referring to FIGS. 1 and 2, the multi-layered ceramic capacitor 100 according to the embodiment of the present invention may include the ceramic element 110 in which a plurality of dielectric layers 111 are stacked, and a plurality of first and second internal electrodes 130a and 130b having different polarities and alternately stacked in the ceramic element 110.

Both surfaces of the ceramic element 110 may be provided with first and second external electrodes 120a and 120b electrically connected with the first and second internal electrodes 130a and 130b, respectively.

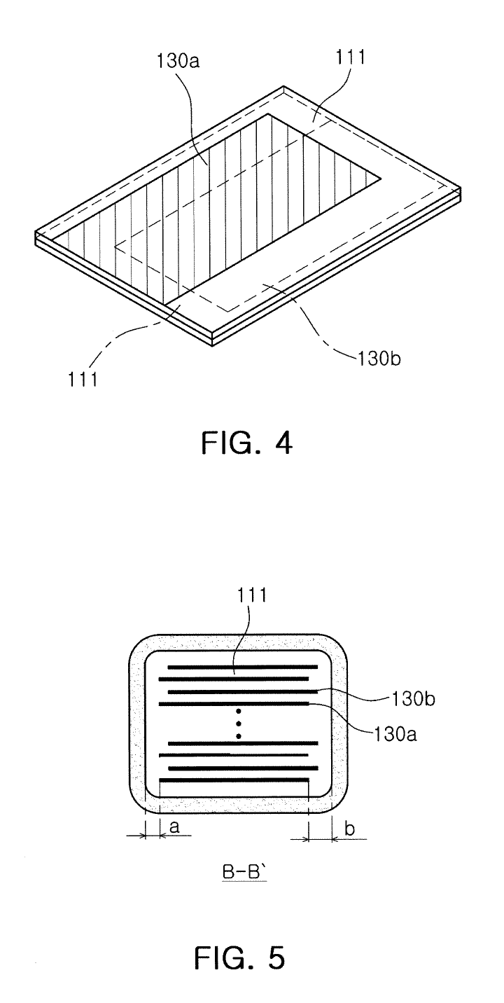

As shown in FIGS. 3 and 4, a distance from an end of the first side 200 of the dielectric layer 111 to a leading edge of the first internal electrode 130a in a width direction is set to be B, and a distance from an end of the first side 200 of the dielectric layer 111 to a leading edge of the second internal electrode 130b in a width direction is set to be A.

In this configuration, a difference between A and B may be set to be 10 to 14% of one width C of the first internal electrode 130a and the second internal electrode 130b. A relative numerical value of A, B, and C will be described in detail with reference to the following detailed embodiments.

In this case, the first and second internal electrodes 130a and 130b may be formed to have the same width, but the embodiment of the present invention is not limited thereto and may also be configured to have different widths, if necessary.

The ceramic element 110 is not particularly limited in view of a shape, but may generally have a rectangular parallelepiped shape.

A dimension of the ceramic element 110 is not particularly limited but is configured to have, for example, a size of 0.6 mm×0.3 mm, or the like, such that a multi-layered ceramic capacitor 100 having relatively high capacity of 1.0 μF or more may be configured.

The dielectric layers 111 configuring the ceramic element 110 may include ceramic powder, for example, BaTiO₃ based ceramic powder, or the like.

The BaTiO_{3 based ceramic powder may be (Ba}₁₋xCaₓ)TiO₃,Ba(Ti_{1-y}Ca_{y})O₃, (Ba₁₋ₓCaₓ)(Ti_{1-y}Zr_{y})₃, Ba(Ti_{1-y}Zr_{y})O₃, or the like, to which Ca, Zr, or the like, is partially doped to BaTiO₃, but is not limited thereto.

An average particle size of the ceramic powder may be 0.8 μm or less, and more specifically, may be 0.05 to 0.5 μm, but is not limited thereto.

In this case, the dielectric layer 111 may further include at least one of transition metal oxide or carbide, rare earth elements, Mg, and Al in addition to the ceramic powder, as necessary.

In addition, the thickness of the dielectric layer 111 may arbitrarily be changed according to a design of the capacity of the multi-layered ceramic capacitor 100. In the embodiment of the present invention, the thickness of each dielectric layer 111 may be configured to have 1.0 μm or less, and specifically, may be 0.01 to 1.0 μm, but is not limited thereto.

The first and second internal electrodes 130a and 130b maybe formed on the ceramic green sheet forming the dielectric layer 111 and may be vertically stacked.

Further, the first and second internal electrodes 130a and 130b may be disposed to face each other along the stacked direction in the ceramic element 110, having one dielectric layer 111 therebetween.

The thickness of the first and second internal electrodes 130a and 130b may be determined according to applications. For example, the thickness of the first and second internal electrodes 130a and 130b may be determined so as to be in the range of 0.01 to 1.0 μm in consideration of the size of the ceramic element 110.

Further, ends of the first and second internal electrodes 130a and 130b may be exposed on one surface of the ceramic element 110. In the embodiment of the present invention, both ends of the first and second internal electrodes 130a and 130b may be alternately exposed to both opposing ends of the ceramic element 110.

As described above, in forming the first and second internal electrodes 130a and 130b on the dielectric layer 111, a margin part having a predetermined width may be provided with respect to a width direction of the first and second internal electrodes 130a and 130b.

The margin part may serve to prevent moisture from being penetrated into the first and second internal electrodes 130a and 130b after forming the ceramic element 110 by stacking each dielectric layer 111.

In addition, the margin part may also serve to protect the first and second internal electrodes 130a and 130b from external impact, thereby preventing the electrical short.

According to the above-mentioned configuration, when observing the entire structure of the ceramic element 110 of the multi-layered ceramic capacitor 100, there is a height difference corresponding to the thickness of the first and second internal electrodes 130a and 130b, between a central portion at which the first and second internal electrodes 130a and 130b are formed and both edges at which the internal electrodes 130a and 130b are not formed but the margin parts are formed.

The step between the central portion and both edges of the ceramic element 110 may generate so-called delamination delaminating the stacked dielectric layers 111 from each other during the manufacturing process, in particular, the firing process or generate fine cracks inside the ceramic element 110.

Further, the electrical field may be concentrated at the edge portion of the thin dielectric layer 111 and thus, the operating reliability of the multi-layered ceramic capacitor 100 may be degraded.

In addition, usable widths of the first and second internal electrodes 130a and 130b maybe relatively reduced by the margin parts and thus, the capacity of the multi-layered ceramic capacitor 100 may be degraded.

Therefore, in order to solve the degradation in the capacity of the capacitor, the margin part between the leading edge of the dielectric layer 111 and the first and second internal electrodes 130a and 130b may be formed to have a relatively minimum width within the range that can prevent the penetration of moisture and provide the durability against the external impact.

Further, in order to prevent the generation of the delamination and the cracks, there is a need to significantly reduce the step between the dielectric layers 111.

In the embodiment of the present invention, the positions of the first and second internal electrodes 130a and 130b formed on the dielectric layers 111 may not be consistent with each other and therefore, the first and second internal electrodes 130a and 130b positioned above and below may be positioned differently when the plurality of dielectric layers 111 are stacked.

That is, overlapping portions of the first and second internal electrodes 130a and 130b, provided on the vertically stacked dielectric layers 111, do not have a consistent shape, but are stacked in shapes inconsistent with each other, that is, crosswise with regard to each other, to thus significantly reduce the step of the central portion and the surrounding portion of the ceramic element 110.

As described above, in order to allow the corresponding positions of the first and second internal electrodes 130a and 130b to be differentiated from each other in positions thereof, the distance B from the first side 200 that is a front side of the dielectric layer 111 to the leading edge of the first internal electrode 130a in the width direction and the distance A from the first side 200 of the dielectric layer 111 to the leading edge of the second internal electrode 130b in the width direction may be set to be different from each other.

In this configuration, a difference between A and B may be set to be 10 to 14% of one width C of the first internal electrode 130a and the second internal electrode 130b.

The numeral value may be in the range of preventing moisture from penetrating into the first and second internal electrodes 130a and 130b and preventing the occurrence of the delamination and cracks and the degradation in capacity of the capacitor while providing the durability against the external impact.

Therefore, according to the above-mentioned configuration, the electrical field of the ceramic element 110 may be suppressed from being concentrated at the edge portion of the first and second internal electrodes 130a and 130b by distributing charges, to thus reduce the step of the central portion and the surrounding portion of the ceramic element 110, thereby improving the occurrence of the delamination and the cracks.

Meanwhile, the distance, from the second side 210 that is opposite to the first side 200 of the ceramic element 110, to the leading edge of the first internal electrode 130a in the width direction, may be equally set to the distance A that is the distance from the first side 200 of the ceramic element 110 to the leading edge of the second internal electrode 130b in the width direction.

In addition, the distance, from the second side 210 that is opposite to the first side 200 of the ceramic element 110, to the leading edge of the second internal electrode 130b in the width direction, may be equally set to the distance B that is the distance from the first side 200 of the ceramic element 110 to the leading edge of the first internal electrode 130a in the width direction.

That is, the positions of the first and second internal electrodes 130a and 130b positioned above and below are bilaterally symmetrical with each other, based on line B-B′ in a direction of line B-B′, thereby further preventing the step in the height from locally occurring at the time of stacking the dielectric layer 111.

The more detailed embodiment of the present invention will be described below with reference to Comparative Examples thereof, by way of example.

As described above, the distance from the first side 200 of the dielectric layer 111 to the leading edge of the first internal electrode 130a in the width direction is set to be B, the distance from the first side 200 of the dielectric layer 111 to the leading edge of the second internal electrode 130b in the width direction is set to be A, and the width of the first internal electrode 130a or the second internal electrode 130b is set to be C, whereby the characteristics of the multi-layered ceramic capacitor were measured as in the following Table 1.

For the evaluation, after the chip was manufactured by printing the first and second internal electrodes 130a and 130b on a molding sheet having a thickness of 2 μm in order of size, the width of margin part B, that is, the distance B, was fixed to one of 70, 100, 150, 200, and 270, and the width of margin part A, that is, the distance A, was variously changed, and then the water-resistance reliability and the high-temperature reliability were measured. In this case, the width C of the second internal electrode 130b was changed so as to respectively correspond to 180, 360, 700, 1000, and 1300 according to the width of the margin part B.

Thereafter, the number in which defects occur among 400 in the case of the water-resistance reliability, and the number in which defects occur among 100 in the case of the high-temperature reliability, were confirmed.

Further, the number in which the delamination and the cracks occur in the fired chip was confirmed by confirming the section portion of the fired chip in the width direction and the lengthwise direction.

TABLE 1

| | | | | | | Delamina- | Poor in Water- | Poor in High- | |
|---|---|---|---|---|---|---|---|---|---|
| | | | | D | D/C | tion & | Resistance | Temperature | Evalu- |
| NO | A | B | C | (B-A) | (%) | Crack (EA) | Reliability (EA) | Reliability (EA) | ation |
| 1 | 14 | 70 | 180 | 56 | 31% | 0/100 | 2/400 | 1/100 | Δ |
| 2 | 24.5 | 70 | 180 | 45.5 | 25% | 0/100 | 1/400 | 0/100 | Δ |
| 3 | 45.5 | 70 | 180 | 24.5 | 14% | 0/100 | 0/400 | 0/100 | ⊚ |
| 4 | 49 | 70 | 180 | 21 | 12% | 0/100 | 0/400 | 0/100 | ⊚ |
| 5 | 56 | 70 | 180 | 14 | 8% | 1/100 | 0/400 | 2/100 | Δ |
| 6 | 5 | 100 | 360 | 95 | 26% | 0/100 | 3/400 | 0/100 | Δ |
| 7 | 20 | 100 | 360 | 80 | 22% | 0/100 | 2/400 | 0/100 | Δ |
| 8 | 50 | 100 | 360 | 50 | 14% | 0/100 | 0/400 | 0/100 | ⊚ |
| 9 | 60 | 100 | 360 | 40 | 11% | 0/100 | 0/400 | 0/100 | ⊚ |
| 10 | 70 | 100 | 360 | 30 | 8% | 0/100 | 0/400 | 2/100 | Δ |
| 11 | 7.5 | 150 | 700 | 142.5 | 20% | 2/100 | 5/400 | 0/100 | Δ |
| 12 | 30 | 150 | 700 | 120 | 17% | 0/100 | 3/400 | 0/100 | Δ |
| 13 | 52.5 | 150 | 700 | 97.5 | 14% | 0/100 | 0/400 | 0/100 | ⊚ |
| 14 | 75 | 150 | 700 | 75 | 11% | 0/100 | 0/400 | 0/100 | ⊚ |
| 15 | 97.5 | 150 | 700 | 52.5 | 8% | 2/100 | 0/400 | 2/100 | Δ |
| 16 | 10 | 200 | 1000 | 190 | 19% | 2/100 | 4/400 | 0/100 | Δ |
| 17 | 40 | 200 | 1000 | 160 | 16% | 0/100 | 2/400 | 0/100 | Δ |
| 18 | 70 | 200 | 1000 | 130 | 13% | 0/100 | 0/400 | 0/100 | ⊚ |
| 19 | 100 | 200 | 1000 | 100 | 10% | 0/100 | 0/400 | 0/100 | ⊚ |
| 20 | 130 | 200 | 1000 | 70 | 7% | 0/100 | 0/400 | 1/100 | ◯ |
| 21 | 13.5 | 270 | 1300 | 256.5 | 20% | 2/100 | 8/400 | 0/100 | Δ |
| 22 | 54 | 270 | 1300 | 216 | 17% | 0/100 | 3/400 | 0/100 | Δ |
| 23 | 94.5 | 270 | 1300 | 175.5 | 14% | 0/100 | 0/400 | 0/100 | ⊚ |
| 24 | 135 | 270 | 1300 | 135 | 10% | 0/100 | 0/400 | 0/100 | ⊚ |
| 25 | 175.5 | 270 | 1300 | 94.5 | 7% | 0/100 | 0/400 | 1/100 | ◯ |

⊚ Excellent ◯ Normal Δ Poor

<Comparison of Characteristics of Multi-Layered Ceramic Capacitor According to Ratio of Margin Part of Dielectric Layer to Width of Internal Electrode>

Referring to Table 1, samples 1, 2, 6, 7, 11, 12, 16, 17, 21 and 22 are Comparative Examples, and showed that the difference between the margin part B of the first internal electrode 130a and the margin part A of the second internal electrode 130b exceeds 14% with respect to a width of one of the first internal electrode 130a and the second internal electrode 130b.

In this case, the widths of the margin parts A and B are too narrow and the widths of the first and second internal electrodes 130a and 130b are relatively too large and thus, the defective products were frequently found at the time of the evaluation of the water-resistance reliability.

Further, in some products, poor products were found at the time of the evaluation of the high-temperature reliability.

Further, it was found that there were some products having the delamination or the cracks occurring in the dielectric layer 111.

Samples 5, 10, 15, 20, and 25 correspond to the Examples according to the related art, and showed that the internal electrodes 130a and 130b are stacked while vertically overlapping each other without the difference in length between the margin part B of the first internal electrode 130a and the margin part A of the second internal electrode 130b.

In this case, the widths of the first and second internal electrodes 130a and 130b are secured to have a predetermined value and thus, the poor products were not found at the time of the evaluation of the water-resistance reliability.

However, some of the poor products were found at the time of the evaluation of the high-temperature reliability. Further, it was found that there were some products having the delamination or the cracks occurring in the dielectric layer 111.

Samples 3, 4, 8, 9, 13, 14, 18, 19, 23, and 24 correspond to the embodiment of the present invention and represent that the difference between the margin part B of the first internal electrode 130a and the margin part A of the second internal electrode 130B is 10 to 14% with respect to the width of one of the first internal electrode 130a and the second internal electrode 130b.

In this case, no defective products were found at the time of the evaluation of the water-resistance reliability or the high-temperature reliability. Further, no products having the delamination or the cracks occurring in the dielectric layer 111 were found.

Therefore, when the difference between the margin part B of the first internal electrode 130a and the margin part A of the second internal electrode 130b is 10 to 14% with respect to the width of one of the first internal electrode 130a and the second internal electrode 130b, it could be appreciated that the reliability is excellent when comparing with the above-mentioned Comparative Examples and the Prior Examples.

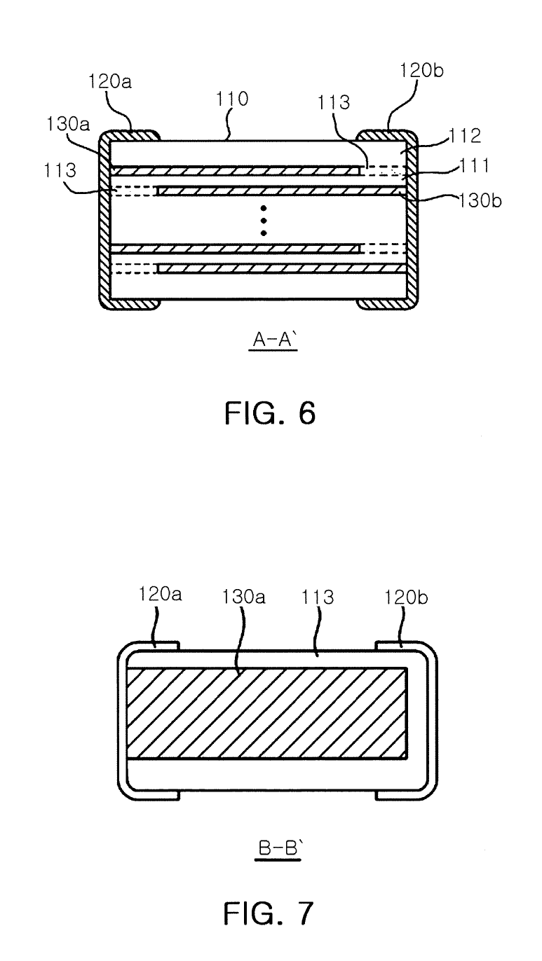

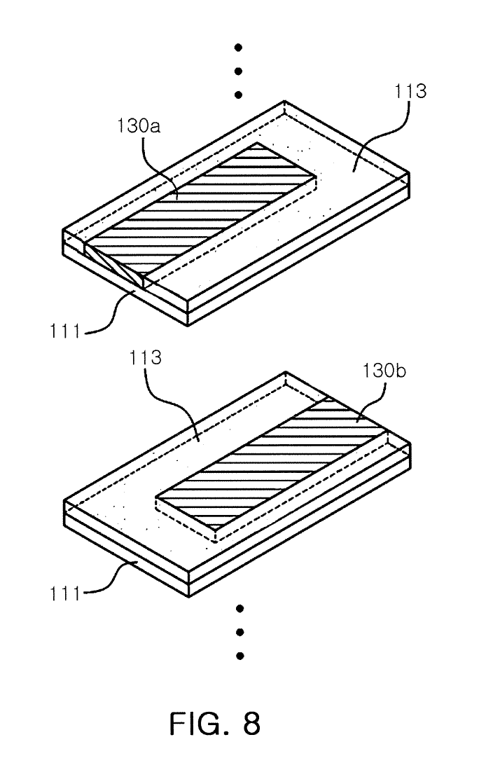

Meanwhile, referring to FIGS. 6 to 8, the multi-layered ceramic capacitor according to another embodiment of the present invention may include a portion in which the first and second internal electrodes 130a and 130b are not formed on one surface of the dielectric layer 111, that is, a margin part dielectric layer 113 formed on the margin part.

The margin part dielectric layer 113 may be formed to be equal or similar to the height of the first and second internal electrodes 130a and 130b formed on the dielectric layer 111.

Therefore, the step generated by the first and second internal electrodes 130a and 130b may be prevented by the margin part dielectric layer 113, and the diffusion of the first and second internal electrodes 130a and 130b may be prevented.

Further, the outermost surface of the ceramic element 110 may be formed with the cover part dielectric layer 112 having a predetermined thickness.

Hereinafter, a method of manufacturing a multi-layered ceramic capacitor according to an embodiment of the present invention will be described.

First, a plurality of ceramic green sheets are prepared. The ceramic green sheets are to form the dielectric layer 111 of the ceramic element 110.

The ceramic green sheet may be manufactured by preparing slurry by mixing a ceramic powder, a polymer, and a solvent and producing the slurry in a sheet shape having a thickness of several μm by a mechanism such as Doctor Blade, or the like.

Thereafter, the first and second internal electrodes 130a and 130b may be formed by printing a conductive paste on the ceramic green sheet at a predetermined thickness, for example, a thickness of 0.1 to 2.0 μm, wherein the thickness of the first and second internal electrodes 130a and 130b is not limited thereto.

In addition, the first and second internal electrodes 130a and 130b may be formed on one surface of the ceramic green sheet with a predetermined margin part and may be formed to be stacked in the shape in which the overlapping portion of the first and second internal electrodes 130a and 130b positioned above and below crosses each other, that is, are inconsistent with each other in the stacked shape thereof, when the plurality of ceramic green sheets are stacked.

In this case, when the distance from one side of the ceramic green sheet to the leading edge of the first internal electrode 130a in the width direction is set to be B and the distance from one side of the ceramic green sheet to the leading edge of the second internal electrode 130b in the width direction is set to be A, the conductive paste may be printed on the ceramic green sheet so that the difference between A and B is 10 to 14% of the width C of one of the first internal electrode 130a and the second internal electrode 130b.

Meanwhile, the distance from the other side of the ceramic green sheet to the leading edge of the first internal electrode 130a in the width direction may be set to be B, and the distance from the other side of the ceramic green sheet to the leading edge of the second internal electrode 130b in the width direction may be set to be A.

That is, the ceramic green sheet on which the first internal electrode 130a is formed and the ceramic green sheet on which the second internal electrode 130b is formed may be formed so as to be bilaterally symmetrical with each other with respect to the length direction, thereby significantly reducing the occurrence of local steps at the time of stacking the ceramic green sheets.

As the printing method of the conductive paste, a screen printing method, a gravure printing method, or the like, may be used.

Further, the conductive paste may include a metal powder, a ceramic powder, silica (SiO₂) powder, or the like.

As the metal powder, one of nickel (Ni), manganese (Mn), chromium (Cr), cobalt (Co), and aluminum (Al) may be used, or an alloy thereof may be used.

Further, the average particle size of the conductive paste may be 50 to 400 nm, but is not limited thereto.

Therefore, the plurality of ceramic green sheets may be stacked and may be pressed from the stacked direction, thereby compressing the stacked ceramic green sheets and the internal electrode paste with each other.

That is, the ceramic element 110 may be configured to have the shape in which the plurality of dielectric layers 111 and the plurality of first and second internal electrodes 130a and 130B are alternately stacked and the vertically overlapping portions cross each other.

Thereafter, the ceramic element 110 may be cut for each region corresponding to one capacitor, which is in turn formed in a chip type.

In this case, the ceramic element 110 may be completed by cutting ends of the first and second internal electrodes 130a and 130b so as to be alternately exposed through the end and being fired at the high temperature.

Thereafter, the ceramic capacitor 100 may be completed by forming the first and second external electrodes 120a and 120b so as to cover both ends of the ceramic element 110.

The first and second external electrodes 120a and 120b may be electrically connected with the first and second internal electrodes 130a and 130b exposed to the end of the ceramic element 110, and the surfaces of the first and second external electrodes 120a and 120b may be plated with nickel, tin, or the like, if necessary.

As set forth above, according to the embodiments of the present invention, the high charge density at the edge portion of the internal electrode may be reduced by improving the pattern structure of the internal electrode of the multi-layered ceramic electronic component.

While the present invention has been shown and described in connection with the embodiments, it will be apparent to those skilled in the art that modifications and variations can be made without departing from the spirit and scope of the invention as defined by the appended claims.

What is claimed is:

1. A multi-layered ceramic electronic component, comprising:
a ceramic element including a plurality of dielectric layers stacked therein; and
a plurality of first and second internal electrodes formed on at least one surface of the dielectric layer and alternately stacked to have shapes inconsistent with each other in a width direction,
wherein, when a distance from one side of the ceramic element to a leading edge of the first internal electrode in a width direction is set to be B, and a distance from one side of the ceramic element to a leading edge of the second internal electrode in a width direction is set to be A, a difference between A and B is 10 to 14% of a width of the first internal electrode or the second internal electrode.

2. The multi-layered ceramic electronic component of claim 1, wherein the widths of the first internal electrode and the second internal electrode are the same.

3. The multi-layered ceramic electronic component of claim 1, wherein the distance from one side of the ceramic element to the leading edge of the first internal electrode in a width direction is the same as the distance from the other side of the ceramic element, opposite to one side thereof, to the leading edge of the second internal electrode in a width direction.

4. The multi-layered ceramic electronic component of claim 1, further comprising first and second external electrodes formed on both end surfaces of the ceramic element and electrically connected with the first and second internal electrodes.

5. The multi-layered ceramic electronic component of claim 1, further comprising margin part dielectric layers formed on margin parts of the dielectric layers in which the first and second internal electrodes are not formed.

6. The multi-layered ceramic electronic component of claim 1, wherein the first and second internal electrodes are disposed to face each other in a stacked direction of the ceramic element, having one dielectric layer therebetween.

7. A method of manufacturing multi-layered ceramic electronic components, comprising:
forming first and second internal electrode layers on at least one surface of first and second ceramic sheets so as to form a margin part;
forming a laminate by alternately stacking the first and second ceramic sheets, each formed with the first and second internal electrode layers, several times; and
firing the laminate,
wherein in the forming of the first and second internal electrode layers, the margin part is formed so that the first and second internal electrode layers are alternately disposed to be inconsistent with each other in a width direction at the time of forming the laminate, and when a distance from one side of the ceramic element to a leading edge of the first internal electrode in a width direction is set to be B, and a distance from one side of the ceramic element to a leading edge of the second internal electrode in the width direction is set to be A, a difference between A and B is 10 to 14% of a width of the first internal electrode or the second internal electrode.

8. The method of claim 7, wherein the widths of the first internal electrode layer and the second internal electrode layer are the same.

9. The method of claim 7, wherein in the forming of the first and second internal electrode layers, the distance from one side of the ceramic sheet to the leading edge of the first internal electrode layer in the width direction is the same as the distance from the other side of the second ceramic sheet, opposite to one side thereof, to the leading edge of the second internal electrode layer in the width direction.

10. The method of claim 7, further comprising forming first and second external electrodes formed on both surfaces of the laminate and electrically connected with the first and second internal electrode layers.

11. The method of claim 7, further comprising forming margin part dielectric layers on margin parts of the first and second ceramic sheets in which the first and second internal electrode layers are not formed.
